(19) United States
(12) Patent Application Publication
(10) Pub. No.: US 2011/0080095 A1
(43) Pub. Date: Apr. 7, 2011

(54) FILAMENT ELECTRICAL DISCHARGE ION SOURCE

(75) Inventors: Maxime Makarov, Viroflay (FR); Marc Mestres, Le Houga (FR)

(73) Assignee: EXCICO GROUP, Antwerpen (BE)

(21) Appl. No.: 12/812,246

(22) PCT Filed: Jan. 8, 2009
(86) PCT No.: PCT/FR2009/000016

§ 371 Date: Dec. 3, 2010

(30) Foreign Application Priority Data
Jan. 11, 2008 (EP) 0890027.5

(51) Int. Cl. H05B 31/26

(52) U.S. Cl. 315/111.81

(57) ABSTRACT

Filament electric discharge ion source (1) including an ionization chamber (3) provided with internal walls and configured so as to contain a gas to be ionized, filaments (13) placed in the ionization chamber (3) and a power supply (19) for applying voltage to the filaments, in which the filaments (13) are placed so as to be substantially parallel to one another and connected to the power supply (19) through the internal walls, at least one first filament being connected to the power supply through a first internal wall and at least one second filament being connected to the power supply through a second internal wall opposite the first internal wall.

The invention relates to the field of pulsed ion sources and devices that use such sources, for example plasma generators.

The publication U.S. Pat. No. 3,156,842 relates to a gas ioniser comprising a hollow electrode shaped as a figure of revolution, an electrode in the form of a rod positioned along the axis of the hollow electrode and with a cross-section very much smaller than that of the hollow electrode, means for supplying a gas at very low pressure into the space defined by the hollow electrode, and means for keeping the electrons away from the ends of the hollow electrode.

Reference may also be made to the publications U.S. Pat. No. 3,970,892, U.S. Pat. No. 4,025,818, U.S. Pat. No. 4,642,522, U.S. Pat. No. 4,694,222, U.S. Pat. No. 4,910,435 and FR 2 591 035.

If an electrode is in the form of a fine filament, it has proved difficult to produce a large-size ion source with a strong, homogeneous current. In fact, the electrical discharge forms heterogeneously along the filament and is found to be unstable. The filament may become locally incandescent. It may be that the inner surface of the walls of the chamber develops greater emitting properties. It is possible to envisage using a number of long filaments mounted in parallel along the axis of the discharge chamber. However, the discharge then takes place heterogeneously along the filaments and mechanical difficulties arise linked to the expansion and vibration of the filament. If a number of short filaments mounted perpendicularly to the axis of the discharge chamber are used, the mechanical device becomes complicated, notably as a result of the presence of numerous pathways through walls that are gastight and electrically insulated. It is possible to envisage supplying each filament separately. Multiple electrical power supplies are then required, which makes the electrical part of the installation considerably more complicated.

Moreover, it is still difficult to form a discharge that fills the low pressure chamber in a stable, homogeneous manner.

The invention sets out in particular to remedy the drawbacks of the prior art as set out above.

The invention aims particularly to provide a large-size ion source that is homogeneous and stable.

A filament electrical discharge ion source comprises an ionisation chamber provided with internal walls and configured so as to contain a gas that is to be ionised, filaments arranged in the ionisation chamber, and a electrical power supply to the filaments. The filaments are arranged substantially parallel to one another and connected to the power supply through the internal walls. At least one first filament is connected to the power supply through a first internal wall and at least one second filament is connected to the power supply through a second internal wall opposite the first internal wall.

The Applicant has in fact realised that supplying filaments with current in a crosswise manner in which filaments are supplied by the opposite sides of the ionisation chamber can substantially reduce the negative effect that the magnetic field has on the ionisation of the gas. The current, reaching several hundred ampères, generates a fairly strong magnetic field, for example in the order of several thousandths of a tesla at a distance of one centimetre from the filament, so that the gyratory radius of a free electron is in the order of 0.03 mm and hence substantially less than the mean free path. For such an electron, it is then very unlikely to ionise the gas. A crosswise power supply makes it possible to reduce the magnetic field by a factor of the order of 10 to 100.

The filaments may be mounted in even numbers. The number of filaments may be 2, 4, 6, 8 or even 10. If the number of filaments is greater than or equal to 4, the arrangement of the filaments may be such that a first filament is adjacent to a plurality of second filaments and a second filament is adjacent to a plurality of first filaments. The term “adjacent” may be understood to mean the closest neighbour.

In the case of an assembly with four filaments, these filaments may be arranged in a square, viewed in cross-section, with the first filaments along one diagonal and the second filaments along the other diagonal. The four filaments may also be arranged in a planar layer, the first filaments and second filaments alternating with one another. In the case of an assembly with six filaments, these filaments may be in a hexagonal arrangement with first and second filaments alternating, in a rectangular arrangement, or in a planar layer arrangement. In the case of an assembly with eight filaments, these filaments may be arranged in two groups of four, separated by a spacer that is larger than the space separating two adjacent filaments, in a rectangle with constant spacing, in an octagon, in a planar layer, etc.

The power supply may be configured so as to provide a current of less than one ampère per centimetre of length of the filament. This promotes homogeneity in the discharge.

In one embodiment, the filaments are parallel to an axis of the ionisation chamber. The filaments may be parallel to the longitudinal axis of the ionisation chamber. The number of electrical pathways through the gastight walls is then low.

In one embodiment, the filaments are parallel to one axis of an acceleration chamber.

The minimum spacing between two filaments may be greater than 40, preferably 50, times the diameter of a filament. In this way a certain independence of the discharge of each filament in operation is obtained. Vibration, incorrect positioning or lack of straightness of a filament causes only negligible disruption to the discharge around an adjacent filament. The filaments may be equal in diameter.

The minimum internal perimeter of the ionisation chamber may be greater than the product of a constant, the number of filaments in the ionisation chamber, the diameter of the filaments and a parameter representing the atomic mass of the gas present in the ionisation chamber. The minimum internal perimeter of the ionisation chamber may be greater than 100 times the product of the number of filaments in the ionisation chamber, the diameter of a filament and the square root of the atomic mass of the gas present in the ionisation chamber. In this way the homogeneity of the discharge is improved.

In one embodiment, the filaments comprise tungsten, for example a tungsten alloy. The filaments may comprise a metal with a melting point above 2000 K. The filaments are preferably made of a hard metal treated to withstand high temperatures.

In one embodiment, the filaments have a diameter of between 0.1 and 0.5 mm, preferably between 0.15 and 0.3 mm.

In one embodiment, the pressure of the gas to be ionised in the ionisation chamber is between 0.5 and 100 pascals, preferably between 1 and 20 pascals.

In one embodiment, the gas to be ionised comprises helium.

In one embodiment, the gas to be ionised comprises helium and 5% to 25% by mass of neon, preferably between 5 and 15%. The spatial homogeneity of the discharge is improved.

In one embodiment, the number of filaments is determined by the total current provided by the electrical power supply.

In one embodiment, the perimeter of the cross-section of the ionisation chamber is determined by the diameter of the filaments, the number of filaments and the nature of the gas present in the ionisation chamber.

There may be a single electrical power supply to the filaments.

The present invention will be better understood from a study of the detailed description of a number of embodiments taken as non-restrictive examples and illustrated by the appended drawings, wherein:

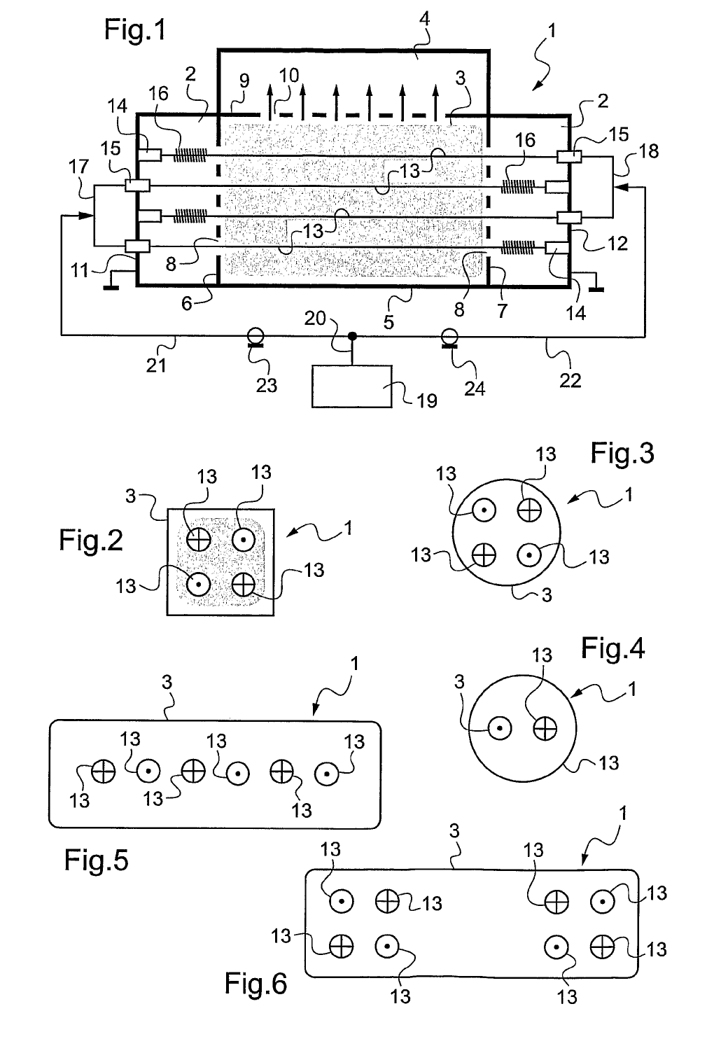

FIG. 1 is a schematic view of an ion source, in longitudinal section; and

FIGS. 2 to 6 are schematic views of ion sources, in cross-section.

As may be seen from FIG. 1, the ion source 1 comprises two connecting chambers 2, an ionisation chamber 3 arranged between the connecting chambers 2 and an ion extracting system 4. The ion extracting system 4 depends on the application in which the ion source 1 is used. The ion extracting system 4 may comprise an acceleration chamber or discharge chamber that enables a high ejection velocity to be imparted to electrons, for example for an electron gun. The ionisation chamber 3 is generally elongate in shape with two ionisation chambers arranged at opposite ends. The ion extracting system 4 may be mounted laterally in relation to the ionisation chamber 3.

The connecting chambers 2, ionisation chamber 3 and ion extracting system 4 form a gastight enclosure. This enclosure may be filled with noble gas, notably helium, neon and/or argon. The gas pressure prevailing in the enclosure may be between 0.5 pascal and 100 pascals, a pressure of between 1 pascal and 20 pascals being preferred.

The ionisation chamber 3 comprises a leaktight lower wall 5 and two end walls 6 and 7 which are shared with the connecting chambers 2. Through-openings 8 are formed in the end walls 6 and 7. The ionisation chamber 3 comprises an upper wall 9 that is shared with the ion extracting system 4. Ion extracting slots 10 are formed in the wall 9, thereby linking the ionisation chamber 3 and the ion extracting system 4. The front and back walls of the ionisation chamber 3, which are not shown in FIG. 1, are gastight.

The connecting chambers 2 comprise gastight upper and lower walls located on an extension of the lower and upper walls 5 and 9 of the ionisation chamber 4. The connecting chambers 2 are closed off at their ends by ends walls 11 and 12. The walls forming the gastight enclosure may be made of stainless steel or brass and more generally of any metallic material having the mechanical strength required especially as a result of the low internal pressure and the physical and chemical properties linked to ionisation inside the ionisation chamber 3. If desired, a coating of another metal or metal alloy may be formed on the internal walls of the enclosure, for example consisting of aluminium or nickel.

The ionisation chamber 3 comprises a plurality of filaments 13 that are parallel to one another. The filaments 13 are preferably provided in even numbers. The filaments 13 are elongated in the main direction of the ionisation chamber 3. In other words, the filaments 13 are parallel to the main axis of the ionisation chamber 3. The filaments 13 are mounted at a spacing from the lower and upper walls 5 and 9, respectively. The distance between two adjacent filaments 13 is less than the distance between a filament 13 and a lower or upper wall 5 or 9, respectively. The filaments 13 pass into the openings 8 provided in the end walls 6 and 7 of the ionisation chamber 3. The openings 8 thus form a passage for the filaments 13. In an opening 8, a filament 13 remains at a spacing from the material that forms the said end wall 6, 7 of less than 10 times the diameter of the filament.

The ionisation chamber 3 may be cylindrical or toroidal in shape. In this case the filaments 3 may be supported at a number of regularly spaced points by insulators. The filaments may be polygonal.

The connecting chambers 2 comprise support means for the filaments 13. More particularly, a filament 13 is supported at one end by a fixing insulator 14, for example ceramic-based, fixed to an inner surface of an end wall 11, 12 of a connecting chamber 2. At the opposite end of the filament 13, the filament 13 is supported by a leaktight insulator 15 passing through the end wall 12, 11 via an opening provided for this purpose. The insulator 15 acts as an electrical pathway, a mechanical support for the filament 13 and a gastight seal, all at the same time. The electrical pathway enables the filament 13 to be electrically connected to the outside of the ionisation chamber 3 and connecting chamber 2. Moreover, a spring 16 may be interposed between the filament 13 and an insulator, preferably a fixing insulator 14. The spring 16 is arranged in a connecting chamber 2. The spring 16 provides the mechanical tension for the filament 13.

Two adjacent filaments 13 are supported by leaktight insulators 15 arranged one on the end wall 11 and the other on the end wall 12. In other words, the filaments 13 are supplied with power in crosswise manner. In the embodiment shown in FIG. 1 with four filaments 13 arranged in a planar layer, the filaments in rows one and three, numbered from the bottom, are connected to insulators 15 passing through the end wall 11. The filaments 13 in rows two and four are supported by leaktight insulators 15 mounted in the end wall 12.

The filaments 13 in rows one and three are joined together by an electric cable 17. The filaments 13 in tows two and four are joined together by an electric cable 18.

The electrical power supply 19 may comprise a power output 20, for example a single output. The output 20 of the power supply 19 may be connected by a cable 21 to the cable 17 and by a cable 22 to the cable 18, thus providing an electrical power supply to the filaments 13. The electrical power supply may be configured so as to supply a current of an intensity less than or equal to one ampère per centimetre of filament length in each filament 13. Current sensors, for example in the form of current loops 23 and 24, may be mounted on the electric cables 21 and 22, respectively, in order to measure the current passing into said electric cables 21 and 22 and consumed by the filaments 13. The output from the current sensors 23 and 24 may be connected to a control unit for the power supply 19 for regulation purposes.

The diameter of the filaments may be between 0.1 and 0.5 mm. The Applicant has found a diameter of between 0.15 and 0.3 mm, for example 0.2 mm, to be particularly useful. The minimum distance between two filaments is generally more than 40 times the diameter of a filament, preferably 50 times. Thus, for a filament diameter of 0.2 mm, the minimum distance between two filaments is 10 mm. The filaments 13 are made of hard metal or alloy, adapted to withstand high temperatures, notably between 500 and 2000 K. A metal alloy with a melting point of more than 1900 K or even 2000 K may be chosen. The filaments may comprise a refractory metal, for example a tungsten alloy.

The internal perimeter of the ionisation chamber 3 is greater than or equal to the product of a constant, the number of filaments 13 in the ionisation chamber 3, the diameter of the filaments 13 and a parameter relating to the atomic mass of the gas present in the ionisation chamber 3. By way of example, for a source of helium ions with four filaments 0.02 cm in diameter, the perimeter should be greater than 100×0.02 cm×4 ×√2=11.3 cm, which may be obtained by a chamber with a square section of 3.5 cm×3.5 cm or by a tubular chamber 4 cm in diameter. Of course, in the case of a mixture of gases, the parameter representing the atomic mass may be the square root of the weighted mean of the atomic masses of the gases present in the ionisation chamber 3.

In the embodiment shown in FIG. 1, there are four filaments 13 present, arranged in a planar layer. Alternatively, the filaments 13 may be arranged in a plurality of layers, each layer comprising four wires. These layers are parallel to one another and may be arranged relative to one another at a distance equal to the distance between two wires in one layer or at a slightly greater distance. In the embodiment in FIG. 2, there are four wires 13 arranged in a square, viewed in cross-section. The connections and power supplies to the wires are then criss-crossed, in the sense that the wires supplied by leaktight insulators 15 arranged in the wall 11 occupy one diagonal, and the other wires 13 occupy the other diagonal of the square. The ionisation chamber 3 has a square cross-section.

In the embodiment shown in FIG. 3, the arrangement of the wires is similar to that in FIG. 2. The ionisation chamber 3 has a circular cross-section. The ion source 1 then has a generally tubular or toroidal shape.

In the embodiment shown in FIG. 4, the ionisation chamber 3 has a shape similar to that of the embodiment in FIG. 3. There are two filaments 13, one connected to a leaktight insulator 15 supported by the wall 11 and the other connected to a leaktight insulator 15 supported by the end wall 12. The power supply to the filaments 13 comes from opposite ends of the ionisation chamber 3.

In the embodiment shown in FIG. 5, the ionisation chamber 3 has a rectangular cross-section. The ionisation chamber 3 may have the general shape of a right-angled parallelepiped. The ion source 1 comprises six wires arranged in a planar layer. The filaments 13 supplied via the end wall 11 alternate with the filaments 13 supplied via the end wall 12. In the case of a six-wire ion source of generally tubular shape, a hexagonal arrangement of the filaments may be provided. Alternatively, six filaments may be arranged in two layers of three filaments, each layer being planar.

In the embodiment shown in FIG. 6, the ionisation chamber 3 has a generally similar shape to that shown in FIG. 5. The ion source 1 comprises eight filaments 13 arranged in two groups of four spaced from one another, each group of filaments being arranged in a square as shown in FIG. 3. The filaments 13 may also be arranged in a layer of eight wires, in two layers of four wires, or in an octagonal shape.

In operation, the power supply 19 is started up and provides a pulse with a duration of between 1 and 10 microseconds the peak current of which is between 100 and 1000 A, for example, at a voltage between 1 and 10 kV. A discharge takes place between the filaments 13 forming an electrode and the internal walls of the ionisation chamber 3 forming the other electrode. The discharge in the gas produces ions such as He⁺, for example. The ions are able to pass through the slots 10 and be processed by the extraction system 4.

An ion source that is stable in operation is obtained, which generates homogeneous ion fluxes that are particularly well suited for large-scale installations requiring a high ion flow rate.

1. Filament electrical discharge ion source (1), comprising an ionisation chamber (3) provided with internal walls and configured so as to contain a gas that is to be ionised, filaments (13) arranged in the ionisation chamber (3), and an electrical power supply (19) to the filaments, characterised in that the filaments (13) are arranged substantially parallel to one another and connected to the power supply (19) through the internal walls, at least one first filament being connected to the power supply through a first internal wall, at least one second filament being connected to the power supply through a second internal wall opposite the first internal wall.

2. Source according to claim 1, wherein a first filament is adjacent to at least one second filament.

3. Source according to claim 1, wherein the power supply (19) is configured so as to supply a current of less than 1 ampère per centimetre of the filament length.

4. Source according to claim 1, wherein the filaments (13) are parallel to an axis of the ionisation chamber and/or an axis of an acceleration chamber.

5. Source according to claim 1, wherein the minimum distance between two filaments is greater than 40, preferably 50, times the diameter of a filament.

6. Source according to claim 1, wherein the minimum internal perimeter of the ionisation chamber (3) is greater than the product of a constant, the number of filaments (13) in the ionisation chamber (3), the diameter of a filament (13), and a parameter representing the atomic mass of the gas present in the ionisation chamber (3).

7. Source according to claim 6, wherein the minimum internal perimeter of the ionisation chamber (3) is more than 100 times the product of the number of filaments (13) in the ionisation chamber (3), the diameter of a filament (13) and the square root of the atomic mass of the gas present in the ionisation chamber (3).

8. Source according to claim 1, wherein the filaments (13) comprise a metal with a melting point above 2000 K.

9. Source according to claim 1, wherein the filaments (13) have a diameter of between 0.1 and 0.5 mm, preferably between 0.15 and 0.3 mm.

10. Source according to claim 1, wherein the pressure of gas to be ionised in the ionisation chamber (3) is between 0.5 and 1 Pa, preferably between 1 and 20 Pa.

11. Source according to claim 1, wherein the gas to be ionised comprises helium and 5 to 25% of neon, preferably between 5 and 15%.

12. Source according to claim 2, wherein the power supply (19) is configured so as to supply a current of less than 1 ampère per centimetre of the filament length.

13. Source according to claim 2, wherein the filaments (13) are parallel to an axis of the ionisation chamber and/or an axis of an acceleration chamber.

14. Source according to claim 3, wherein the filaments (13) are parallel to an axis of the ionisation chamber and/or an axis of an acceleration chamber.

15. Source according to claim 2, wherein the minimum distance between two filaments is greater than 40, preferably 50, times the diameter of a filament.

16. Source according to claim 3, wherein the minimum distance between two filaments is greater than 40, preferably 50, times the diameter of a filament.

17. Source according to claim 4, wherein the minimum distance between two filaments is greater than 40, preferably 50, times the diameter of a filament.

18. Source according to claim 2, wherein the minimum internal perimeter of the ionisation chamber (3) is greater than the product of a constant, the number of filaments (13) in the ionisation chamber (3), the diameter of a filament (13), and a parameter representing the atomic mass of the gas present in the ionisation chamber (3).

19. Source according to claim 3, wherein the minimum internal perimeter of the ionisation chamber (3) is greater than the product of a constant, the number of filaments (13) in the ionisation chamber (3), the diameter of a filament (13), and a parameter representing the atomic mass of the gas present in the ionisation chamber (3).

20. Source according to claim 4, wherein the minimum internal perimeter of the ionisation chamber (3) is greater than the product of a constant, the number of filaments (13) in the ionisation chamber (3), the diameter of a filament (13), and a parameter representing the atomic mass of the gas present in the ionisation chamber (3).
